(19) United States
(12) Patent Application Publication
(10) Pub. No.: US 2006/0003908 A1
(43) Pub. Date: Jan. 5, 2006

(54) Mild synthetic detergent toilet bar composition

(76) Inventors: Michael A. Brennan, Sandy Hook, CT (US); Syed Husain Abbas, Seymour, CT (US); Michael Massaro, Monroe, CT (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/883,324

(22) Filed: Jul. 1, 2004

(51) Int. Cl. C11D 17/00

(52) U.S. Cl. 510/141

(57) ABSTRACT

Mild toilet bar compositions are described that contain synthetic anionic surfactants, and monohydroxy C16-20 normal alkyl carboxylic acids and have a pH range of 3.0-7.0. The inventive bars have excellent processing properties and can be extruded and stamped into finished toilet bars.

### BACKGROUND OF THE INVENTION

1. Field of the Invention

The present invention relates to a mild syndet toilet bar with excellent physical and processing properties for cleansing the human body, such as the skin and hair.

2. The Related Art

Synthetic detergent or syndet toilet bars have found considerable use as mild cleansing bars but such bars have the potential to be soft and typically require structuring agents to be added to firm or harden the bar. Thus the main function of prior art structurants such as soap, e.g. sodium stearate, in syndet bars is to provide body and give structure to the product. For example, sodium stearate finds considerable use as a structurant or structuring agent in syndet bar formulations, forming a fibrous network structure which helps in improving the mush and rate of wear properties of the bars. However, there is a problem in structuring syndet bars with reduced soap levels or preferably without soap that have excellent physical and processing properties.

12-Hydroxystearic acid has been previously employed as a structuring agent in high water content soap or syndet bars; see e.g. U.S. Pat. No. 5,225,097 issued to M. Kacher, et al. on Jul. 6, 1993 and U.S. Pat. No. 5,227,086 issued to M. Kacher, et al. on Jul. 13, 1993; which are herein incorporated by reference. JP Kokai publication no. 7034100A, issued to E. Yoshiyuki, et al. on Feb. 3, 1995 describes a syndet bar containing 1 to 30% by weight of a liquid or semi-solid oil and 0.01 to 5% by weight of 12-hydroxystearic acid.

U.S. Pat. No. 5,965,508 to Ospinal et al. issued on Oct. 12, 1999 discloses a toilet bar that is either a syndet, combo, or a detergent bar containing sulfonated methyl esters, and that employs stearic acid as a structurant. U.S. Pat. No. 6,172,026 to Ospinal et al. issued on Jan. 9, 2001 describes a soap bar with alpha sulfonated alkyl esters, sulfonated fatty acids, long chain carboxylic acids and soaps. U.S. Pat. No. 3,247,121 to Hendricks issued on Apr. 19, 1966 discloses a toilet bar containing 50 to 80% soap, 0.5-30% sulfonated methyl esters and 2 to 12% salt used to firm the bar and prevent smear.

Most prior art syndet bars have a pH in the range of about 7 to 8, which is generally considered a neutral pH toilet bar. These bars are much superior in mildness to soap bars which generally have a pH in the range of about 9.5 to 11. During the process of making prior art syndet bars, specific amounts of tallow/coco soap are added to the bar for proper processing and improved latherability. However the addition of soap in syndet formulations increases the bar pH that in turn increases the relative irritation potential of the bar to the skin. Since normal skin pH is in the range of about 5.5-6.0, the most compatible product to the skin will be a product with a pH in the same range.

Unexpectedly it has been found that the use of at least one monohydroxy alkyl carboxylic acid of a specific type can provide structure to syndet bars in conjunction with low Krafft point surfactants and provides acceptable processing and lather. Preferably these carboxylic acids include monohydroxy C16 to C20 normal alkyl carboxylic acids and the like, such as monohydroxy substituted palmitic, stearic, and arachidic acids. These acids are used in syndet formulations as a structurant in place of the major portion of soap, more preferably replacing substantially all of the soap. Although not wishing to be bound by the following theory, it is believed that the use of such low Krafft point surfactants such as e.g. C12-C18 alkyl sulfomethyl esters produce both structuring and a sufficient quantity of liquid crystalline phase to give proper elasticity for processing of the bar. The resulting product has a pH near or at normal skin pH.

### SUMMARY OF THE INVENTION

In one aspect of the invention is a mild toilet bar, including but not limited to the following:
a. about 5 to 80% by wt. of total synthetic anionic surfactant(s);
b. about 1 to 20% by wt. of total surfactant(s) with a Krafft point of less than 30 C;
c. about 0.1 to 10% by wt. of total C16 to C20 normal alkyl mono hydroxy carboxylic acid(s);
d. about 3 to 15% by wt. of water;
e. less than about 10% by wt. of soap(s); and
f. less than about 5% by wt. of total hydrophobic and hydrophilic emollient(s) that are flowable liquids at 25 C (or have a viscosity of less than about 1500 cps below 25 C).

In another aspect of the invention is a toilet bar including but not limited to the following:
a) less than about 5% by weight of total liquid emollient(s) with a melting point below 30 C.;
b) greater than 0.1% of total emollient(s) with a melting point above 30 C;
c) about 5% to 70% by weight of total surfactant(s);
d) more than about 5% by weight of 12-hydroxystearic acid; and
e) less than about 15% by wt. of water.

### DETAILED DESCRIPTION OF THE INVENTION

In one aspect of the invention is a mild toilet bar, including but not limited to the following:
a. about 5 to 80% by wt. of total synthetic anionic surfactant(s), preferably having a lower limit of about 25, 35, or 40% by wt.; and an upper limit of about 80, 65, 55, or 45% by wt.;
b. about 1 to 20% by wt. of total surfactant(s) with a Krafft point of less than 30 C, preferably having a lower limit of about 1, 2, or 5% by wt. and an upper concentration limit of about 20, 15, 10, and 5% by wt.; (advantageously the Krafft point is in the range of about 15-30 C)
c. about 0.1 to 10% by wt. of total C16 to C20 mono hydroxy carboxylic acid(s); (preferably more than about 50, 60, 70 80, or 90% by wt. of total C16 to C20 mono hydroxy carboxylic acid(s) in the bar formulation is 12 hydroxy stearic acid)
d. about 3 to 15% by wt. of water; (preferably the water content of the bar is less than about 10, 8, 6, or 5% by wt.)
e. less than about 10% by wt. of soap(s); and
f. less than about 5% by wt. of total hydrophobic and hydrophilic emollient(s) that are flowable liquids at 25 C (or have a viscosity of less than about 1500 cps below 25 C).

Advantageously the inventive bar contains surfactant(s) with a Krafft point of less than 30 C. These surfactants is/are preferably selected from anionic surfactants, nonionic surfactants, amphoteric surfactants, cationic surfactants and blends thereof. Preferably the bar contains less than about 1% by wt. of soap, more preferably less than 0.1% by wt. of soap, and most preferably less than 0.01% by wt. of soap.

In a preferred embodiment, the inventive bar has a pH of in the range of about 5.0 to 7.5. The pH preferably has a lower limit of about 5.1, 5.3, 5.5, 5.7, or 6.0 and an upper limit of about 7.3, 7.0, 6.8, or 6.5.

Advantageously the low Krafft point surfactant in the inventive bar is selected from C12-C18 sulfonated methyl esters, C12-C18 sulfonated fatty acids, sodium lauryl ether sulfate, betaine, mono lauryl sulfosuccinate, mono cocoamido mea sulfosuccinate, and the like. Preferably the ratio of total synthetic anionic surfactant to low Krafft point surfactant concentration in the bar is in the range of about 2 to 1 to about 100 to 1; more preferably in the range of about 5 to 1 to about 60 to 1.

Preferably the ratio of C16 to C20 normal alkyl monohydroxyacids to flowable liquid emollient at 25 C in the inventive bar is in the range of about 5 to 1 to about 1 to 5. Advantageously the bar further includes hydrophilic emollient(s) at a concentration less than about 50% by wt of total emollient(s), preferably less than about 40, 25 or 20% by wt. Advantageously the bar further includes hydrophobic emollient(s) at a concentration less than about 50% by wt of total emollient(s), preferably less than about 40, 25 or 20% by wt.

In a preferred embodiment the bar contains less than about 6% by weight of water.

In another aspect of the invention is a toilet bar including but not limited to the following:
a) less than about 5% by weight of total liquid emollient(s) with a melting point below 30 C.;
b) greater than 0.1% of total emollient(s) with a melting point above 30 C;
c) about 5% to 70% by weight of total surfactant(s);
d) more than about 5% by weight of 12-hydroxystearic acid; and
e) less than about 15% by wt. of water.

Advantageously the toilet bar contains emollient(s) with a melting point above 30 C include hydrophilic emollients that are selected from polyhydric alcohols, polyols, saccharides, blends thereof, and the like; and hydrophobic emollient(s) selected from triglyceride(s), hydrocarbon(s), silicone(s), fatty acid(s), fatty ester(s), fatty alcohol(s), blends thereof, and the like. In a preferred embodiment, the inventive toilet bar includes at least one acyl isethionate, preferably sodium cocoyl isethionate.

Preferably, 12-hydroxystearic acid is a structuring agent present in the inventive bar where it comprises at least about 20, 30, 40, 50, 60, 70, 80 or 90% by wt. of the total structuring agents in the inventive bar. Most preferably, 12-hydroxystearic acid is substantially the only structuring agent present. Non-soap structuring agents preferably are present in the inventive bar in the concentration range of about 5 to 30% by wt. In the case where 12-hydroxystearic acid is substantially the only structuring agent, it is present in the concentration range of about 10 to 15%, preferably about 13 to 15% by weight in the inventive toilet bar.

In another aspect, the inventive toilet bar is mildly acidic to neutral having a pH range of about 5.0 to 7.0, preferably 5.0 to 6.0, and most preferably 5.3 to 5.7. Preferably the pH of the bar corresponds to the pH of normal skin.

In a further aspect, the inventive toilet bar has a low moisture content, in the range of about 1 to less than or equal to about 15% by weight of water; preferably in the range of about 2 to 13% by weight of water, and most preferably contains less than 12, 10, 9, 8, 7 or 6% by weight of water.

Krafft Point

The Krafft point of a surfactant is defined as the temperature (or more precisely, the narrow temperature range) above which the solubility of a surfactant rises sharply. At this temperature the solubility of the surfactant becomes equal to the critical micelle concentration. It may be determined by locating the abrupt change in slope of a graph of the logarithm of the solubility against temperature or 1/T or can be rapidly estimated using the the rapid estimation procedure described below. High Krafft point surfactants are defined as those that have a Krafft point above 30 C and low Krafft point surfactants are defined as those that have a Krafft point equal to or below 30 C using the rapid estimation technique below.

Plasticizer:

A small quantity of fatty acid soap (i.e. preferably less than about 10, 7, 5, 4, 3, 2, 1, 0.7, 0.5, 0.3, or 0.1% by wt.) with a low Krafft point may be added to the inventive syndet formulation to generate plasticity in the formulation for better binding during the processing of making the bar. Furthermore high Krafft point fatty acid soaps such as palmitate and stearate may be added at a low level (i.e. preferably less than about 10, 7, 5, 4, 3, 2, 1, 0.7, 0.5, 0.3, or 0.1% by wt.) to improve the structuring properties of bar. Although not wishing to be bound by the theory, it is believed that the structure that is created in the inventive bar is due to the microcrystalline fibrous network formation in the formulation. In the current invention a small quantity of a non-soap co-surfactant with a low Krafft point may be used to replace about 10, 20, 30, 40, 50, 60, 70, 80, 90, 95, 97, 98, or 99% of the low Krafft point fatty acid soaps to provide plasticity to the formulation while contributing little or no harsh soap content to the bar. Moreover, at least about 10, 20, 30, 40, 50, 60, 70, 80, 90, 95 97, 98 or 99% of the high Krafft point fatty acid soaps are replaced by C16-20 normal alkyl mono-hydroxy fatty acids which can provide network structure to the bar. The ratio of the low krafft point co-surfactant to C16-C20 normal alkyl monohydroxy fatty acids can vary from 2:1 to 2:5.

The most preferred ratio is about 1:1. The combined level of low Krafft point cosurfactants and C16-C20 normal alkyl monohydroxy fatty acids can vary from about 1, 2, 3, 5, 7, 8, 9, 10, 12 or 15% in the formulation. The efficiency of the mono-hydroxy fatty acid as a structurant in the formulation is a function of the chain length.

As stated above, useful mono-hydroxy carboxylic acids include those derived from C16 to C20 normal alkyl carboxylic acids. The most preferred fatty acid is 12-hydroxyl stearic acid. Due to low titer (i.e. the solidification point of the fatty acid), mono hydroxyl acids under C16 are not useful as structurants because they make the formulation soft. Moreover, the ability of monohydroxy fatty acids with chain lengths greater than C20 to form the desired network structure is reduced due to very high titer observed for these acids.

It is further preferred to keep the C16-C20 mono hydroxy acids at a minimum level to avoid the depression of lather in the formulation. Their useful level can vary from about 2-10% by wt. in the formulation, preferably the level is less than about 9, 8, 7, 6, 5, 4, or 3% by wt.

Emollients:

In the current invention the level of total liquid emollients (i.e. emollients that are liquid or flowable at 25 C, preferably those that have a viscosity of less than about 1500 cps at 25 C, can vary from substantially none or about 0.01, 0.1, 0.5, 1, 2, 3, 4, to less than about 5% by wt.

Total liquid emollients may include hydrophilic emollients, hydrophobic emollients, or a combination thereof. Useful hydrophilic emollients can include glycerin, propylene glycol or other water soluble or dispersible alcohols or polyols. Useful hydrophobic emollients can include fatty esters, triglycerides, silicones or other oil soluble or oil dispersible types of materials. The preferred level of the liquid emollient can be in the range of 3 to less than 5% by wt. Higher levels of liquid emollients will likely interfere with the process of making the inventive bars.

Emollients with a titer higher than about 45 C can be added in the formulation up to about 5, 10, 15, 20, 25, 30, 35 or 40% by wt. These emollients can be fatty acids, saturated fats, aliphatic alcohols, waxes, silicones, polysaccharides or any other emollient or blend thereof.

Surfactants:

Surfactants are an essential component of the inventive toilet bar. They are compounds that have hydrophobic and hydrophilic portions that act to reduce the surface tension of the aqueous solutions they are dissolved in. Useful surfactants can include anionic, nonionic, amphoteric, and cationic surfactants, and blends thereof.

Anionic Surfactants:

Synthetic Anionic Surfactants

The toilet bar of the present invention contains one or more non-soap anionic detergents (syndets). Anionic syndet surfactants may be employed at levels up to about 70%, preferably up to about 60%, more preferably up to about 50% and most preferably up to about 40% by wt. The inventive bar may contain such surfactants at levels as low as about 25%, preferably about 30%, more preferably about 35% and most preferably about 40%.

Preferably the syndet surfactants individually or collectively have a zein value of about 50 or less. Zein value may be measured using the test method described below.

The anionic detergent active which may be used may be aliphatic sulfonates, such as a primary alkane (e.g., C₈-C₂₂) sulfonate, primary alkane (e.g., C₈-C₂₂) disulfonate, C₈-C₂₂ alkene sulfonate, C₈-C₂₂ hydroxyalkane sulfonate or alkyl glyceryl ether sulfonate (AGES); or aromatic sulfonates such as alkyl benzene sulfonate.

The anionic may also be an alkyl sulfate (e.g., C₁₂-C₁₈ alkyl sulfate) or alkyl ether sulfate (including alkyl glyceryl ether sulfates). Among the alkyl ether sulfates are those having the formula:
RO(CH₂CH₂O)ₙSO₃M
wherein R is an alkyl or alkenyl having 8 to 18 carbons, preferably 12 to 18 carbons, n has an average value of greater than 1.0, preferably greater than 3; and M is a solubilizing cation such as sodium, potassium, ammonium or substituted ammonium. Ammonium and sodium lauryl ether sulfates are preferred.

The anionic may also be alkyl sulfosuccinates (including mono- and dialkyl, e.g., C₆-C₂₂ sulfosuccinates); alkyl and acyl taurates, alkyl and acyl sarcosinates, sulfoacetates, C₈-C₂₂ alkyl phosphates, alkyl phosphate esters and alkoxyl alkyl phosphate esters, acyl lactates, C₈-C₂₂ monoalkyl succinates and maleates, sulphoacetates, alkyl glucosides and acyl isethionates, and the like.

Sulfosuccinates may be monoalkyl sulfosuccinates having the formula:
R⁴O₂CCH₂CH(SO₃M)CO₂M; and
amide-MEA sulfosuccinates of the formula;
   R⁴CONHCH₂CH₂O₂CCH₂CH(SO₃M)CO₂M
wherein R⁴ ranges from C₈-C₂₂ alkyl and M is a solubilizing cation.

Sarcosinates are generally indicated by the formula:
R¹CON(CH₃)CH₂CO₂M,
wherein R¹ ranges from C₈-C₂₀ alkyl and M is a solubilizing cation.

Taurates are generally identified by formula:
R²CONR³CH₂CH₂SO₃M
wherein R² ranges from C₈-C₂₀ alkyl, R³ ranges from C₁-C₄ alkyl and M is a solubilizing cation.

The inventive toilet bar preferably contains C₆-C₁₈ acyl isethionates. These esters are prepared by reaction between alkali metal isethionate with mixed aliphatic fatty acids having from 6 to 18 carbon atoms and an iodine value of less than 20.

The acyl isethionate may be an alkoxylated isethionate such as is described in Ilardi et al., U.S. Pat. No. 5,393,466, titled “Fatty Acid Esters of Polyalkoxylated isethonic acid; issued Feb. 28, 1995; hereby incorporated by reference. This compound has the general formula:
RC—O(O)—CH(X)—CH₂—(OC(Y)H—CH₂)ₘ—SO₃M⁺
wherein R is an alkyl group having 8 to 18 carbons, m is an integer from 1 to 4, X and Y are hydrogen or an alkyl group having 1 to 4 carbons and M⁺ is a monovalent cation such as, for example, sodium, potassium or ammonium.

In another embodiment of the inventive toilet bar, there is less than 5% by wt. of soap. Preferably there is less than 4, 3, 2, or 1%, and more preferably less than 0.5, 0.3 or 0.1% by wt. of soap. The term “soap” is used herein in its popular sense, i.e., the alkali metal or alkanol ammonium salts of alkane- or alkene monocarboxylic acids. Sodium, potassium, mono-, di- and tri-ethanol ammonium cations, or combinations thereof, are included in this category. In general, sodium, potassium, ammonium, mono-, di-, and tri-ethanol soaps of saturated C8-C14 alkyl chains and unsaturated fatty acids, preferably having C8-C22 alkyl chains, are soluble soaps that are strictly limited in concentration in the present invention.

Amphoteric Surfactants

One or more amphoteric surfactants may be used in this invention. Such surfactants include at least one acid group. This may be a carboxylic or a sulphonic acid group. They include quaternary nitrogen and therefore are quaternary amido acids. They should generally include an alkyl or alkenyl group of 7 to 18 carbon atoms. They will usually comply with an overall structural formula:
R¹—[—C(O)—NH(CH₂)ₙ—]ₘ—N⁺—(R²)(R³)X—Y
where R¹ is alkyl or alkenyl of 7 to 18 carbon atoms;
R² and R³ are each independently alkyl, hydroxyalkyl or carboxyalkyl of 1 to 3 carbon atoms;
n is 2 to 4;
m is 0 to 1;
X is alkylene of 1 to 3 carbon atoms optionally substituted with hydroxyl, and
Y is —CO₂— or —SO₃—

Suitable amphoteric surfactants within the above general formula include simple betaines of formula:
R¹—N⁺—(R²)(R³)CH₂CO₂⁻
and amido betaines of formula:
   R¹—CONH(CH₂)ₙ—N⁺—(R²)(R³)CH₂CO₂⁻
where n is 2 or 3.

In both formulae R¹, R² and R³ are as defined previously. R¹ may in particular be a mixture of C₁₂ and C₁₄ alkyl groups derived from coconut oil so that at least half, preferably at least three quarters of the groups R¹ have 10 to 14 carbon atoms. R² and R³ are preferably methyl.

A further possibility is that the amphoteric detergent is a sulphobetaine of formula:
R¹—N⁺—(R²)(R³)(CH₂)₃SO₃⁻
or
R¹—CONH(CH₂)ₘ—N⁺—(R²)(R³)(CH₂)₃SO₃⁻
where m is 2 or 3, or variants of these in which —(CH₂)₃ SO₃⁻ is replaced by
   —CH₂C(OH)HCH₂SO₃⁻

In these formulae R¹, R² and R³ are as discussed previously.

Amphoacetates and diamphoacetates are also intended to be covered in possible zwitterionic and/or amphoteric compounds which may be used such as e.g., sodium lauroamphoacetate, sodium cocoamphoacetate, and blends thereof, and the like. Amphoteric surfactants may be employed at levels up to 20%, preferably 10%, more preferably 5% and most preferably 2%. The inventive bar may contain such surfactants at levels as low as 0.01%, preferably 0.1%, more preferably 1% and most preferably 2%.

Nonionic Surfactants

One or more nonionic surfactants may also be used in the toilet bar of the present invention. Nonionic surfactants may be employed at levels up to 15%, preferably 10%, more preferably 6% and most preferably 2%. The inventive bar may contain such surfactants at levels as low as 0.1%, preferably 1%, more preferably 1.5% and most preferably 2%.

The nonionics which may be used include in particular the reaction products of compounds having a hydrophobic group and a reactive hydrogen atom, for example aliphatic alcohols, acids, amides or alkylphenols with alkylene oxides, especially ethylene oxide either alone or with propylene oxide. Specific nonionic detergent compounds are alkyl (C₆-C₂₂) phenols ethylene oxide condensates, the condensation products of aliphatic (C₈-C₁₈) primary or secondary linear or branched alcohols with ethylene oxide, and products made by condensation of ethylene oxide with the reaction products of propylene oxide and ethylenediamine. Other so-called nonionic detergent compounds include long chain tertiary amine oxides, long chain tertiary phosphine oxides and dialkyl sulphoxide, and the like.

The nonionic may also be a sugar amide, such as a polysaccharide amide. Specifically, the surfactant may be one of the lactobionamides described in U.S. Pat. No. 5,389,279 to Au et al. titled “Compositions Comprising Nonionic Glycolipid Surfactants issued Feb. 14, 1995; which is hereby incorporated by reference or it may be one of the sugar amides described in U.S. Pat. No. 5,009,814 to Kelkenberg, titled “Use of N-Poly Hydroxyalkyl Fatty Acid Amides as Thickening Agents for Liquid Aqueous Surfactant Systems” issued Apr. 23, 1991; hereby incorporated into the subject application by reference.

Cationic Skin Conditioning Agents

An optional component in compositions according to the invention is a cationic skin feel agent or polymer, such as for example cationic celluloses. Cationic cellulose is available from Amerchol Corp. (Edison, N.J., USA) in their Polymer JR (trade mark) and LR (trade mark) series of polymers, as salts of hydroxyethyl cellulose reacted with trimethyl ammonium substituted epoxide, referred to in the industry (CTFA) as Polyquaternium 10. Another type of cationic cellulose includes the polymeric quaternary ammonium salts of hydroxyethyl cellulose reacted with lauryl dimethyl ammonium-substituted epoxide, referred to in the industry (CTFA) as Polyquaternium 24. These materials are available from Amerchol Corp. (Edison, N.J., USA) under the tradename Polymer LM-200, and quaternary ammonium compounds such as alkyldimethylammonium halogen ides.

A particularly suitable type of cationic polysaccharide polymer that can be used is a cationic guar gum derivative, such as guar hydroxypropyltrimonium chloride (Commercially available from Rhone-Poulenc in their JAGUAR trademark series). Examples are JAGUAR C13S, which has a low degree of substitution of the cationic groups and high viscosity, JAGUAR C15, having a moderate degree of substitution and a low viscosity, JAGUAR C17 (high degree of substitution, high viscosity), JAGUAR C16, which is a hydroxypropylated cationic guar derivative containing a low level of substituent groups as well as cationic quaternary ammonium groups, and JAGUAR 162 which is a high transparency, medium viscosity guar having a low degree of substitution.

Particularly preferred cationic polymers are JAGUAR C13S, JAGUAR C15, JAGUAR C17 and JAGUAR C16 and JAGUAR C162, especially Jaguar C13S. Other cationic skin feel agents known in the art may be used provided that they are compatible with the inventive formulation.

Other preferred cationic compounds that are useful in the present invention include amido quaternary ammonium compounds such as quaternary ammonium propionate and lactate salts, and quaternary ammonium hydrolyzates of silk or wheat protein, and the like. Many of these compounds can be obtained as the Mackine™ Amido Functional Amines, Mackalene™ Amido functional Tertiary Amine Salts, and Mackpro® cationic protein hydrolysates from the McIntyre Group Ltd. (University Park, Ill.).

In a preferred embodiment of the invention having a hydrolyzed protein conditioning agent, the average molecular weight of the hydrolyzed protein is preferably about 2500. Preferably 90% of the hydrolyzed protein is between a molecular weight of about 1500 to about 3500. In a preferred embodiment, MACKPRO™ WWP (i.e. wheat germ amido dimethylamine hydrolyzed wheat protein) is added at a concentration of 0.1% (as is) in the bar. This results in a MACKPRO™ WWP “solids” of 0.035% in the final bar formula for this embodiment.

Cationic polymers may be employed at levels up to about 1%, preferably up to about 0.5%. The inventive bar may contain such polymers at levels as low as about 0.01%, preferably about 0.1%, more preferably about 0.2% and most preferably about 0.3%.

Cationic Surfactants

One or more cationic surfactants may also be used in the inventive toilet bar. Cationic surfactants may be employed at levels up to about 1%, preferably about 0.5%. The inventive bar may contain such surfactants at levels as low as about 0.01%, preferably about 0.1%, more preferably about 0.2% and most preferably about 0.3%.

Examples of cationic detergents are the quaternary ammonium compounds such as alkyldimethylammonium halogenides.

Other suitable surfactants which may be used are described in U.S. Pat. No. 3,723,325 to Parran Jr. titled “Detergent Compositions Containing Particle Deposition Enhancing Agents” issued Mar. 27, 1973; and “Surface Active Agents and Detergents” (Vol. I & II) by Schwartz, Perry & Berch, both of which are also incorporated into the subject application by reference.

Structuring Agents

The inventive toilet bar also contains about 10 to 40% by wt., preferably 20 to 30% by wt. of total structurant In the present invention these structurants include monohydroxy C16 to C20 normal alkyl carboxylic acids and the like, such as monohydroxy substituted palmitic, stearic, and arachidic acids; preferably predominating in 12-hydroxy stearic acid. Preferably the only monohydroxy C16 to C20 normal alkyl carboxylic acid in the toilet bar is 12-hydroxystearic acid. 12-hydroxy stearic acid is preferably present at about 0.1 to 10% by wt., preferably at about 2 to 5% by wt., and most preferably at about 2 to 3% by wt. Structurants are used to enhance the bar integrity, improve the processing properties, and enhance desired user sensory profiles. Suitable co-structurants are generally long chain, preferably normal alkyl (C₈-C₂₄) fatty acids, their esters; branched long chain, preferably normal alkyl (C₈-C₂₄) alcohol or ether derivatives thereof, and blends thereof. These co-structurants are preferably present at a level which allows the pH of the bar to remain in the 5.5 to 6.0 range. It is preferred not to neutralize 12-hydroxystearic acid when it is used as the sole structuring agent in the inventive bar.

The inventive bar also optionally contains fillers selected from inorganic minerals such as calcium sulfate, and the like; and starches, preferably water soluble starches such as maltodextrin and the like and polyethylene wax or paraffin wax, and the like. Fillers may be present in the inventive toilet bar in the range of 1 to 15% by weight, preferably 1 to 5% by weight.

Other co-structuring aids can also be selected from water soluble polymers chemically modified with a hydrophobic moiety or moieties, for example, EO-PO block copolymer, hydrophobically modified PEGs such as POE(200)-glyceryl-stearate, glucam DOE 120 (PEG 120 Methyl Glucose Dioleate), and Hodag CSA-102 (PEG-150 stearate), and Rewoderm® (PEG modified glyceryl cocoate, palmate or tallowate) from Rewo Chemicals.

Other co-structuring aids which may be used include Amerchol Polymer HM 1500 (Nonoxynyl Hydroethyl Cellulose).

In addition, the inventive composition, especially the toilet bar of the invention may include 0 to 15% by wt. optional ingredients as follows:
perfumes; sequestering agents, such as tetrasodium ethylenediaminetetraacetate (EDTA), EHDP or mixtures in an amount of 0.01 to 1%, preferably 0.01 to 0.05%; and coloring agents, opacifiers and pearlizers such as zinc stearate, magnesium stearate, TiO₂, EGMS (ethylene glycol monostearate) or Lytron 621 (Styrene/Acrylate copolymer) and the like; all of which are useful in enhancing the appearance or cosmetic properties of the product.

The compositions may further comprise preservatives such as dimethyloldimethylhydantoin (Glydant XL 1000), parabens, sorbic acid etc., and the like.

The compositions may also comprise coconut acyl mono- or diethanol amides as suds boosters, and strongly ionizing salts such as sodium chloride and sodium sulfate may also be used to advantage.

Antioxidants such as, for example, butylated hydroxytoluene (BHT) and the like may be used advantageously in amounts of about 0.01% or higher if appropriate.

As discussed above, emollients may be advantageously used in the present invention. Emollients which are hydrophilic and also function as humectants such as polyhydric alcohols, e.g. glycerin and propylene glycol, and the like; and polyols such as the polyethylene glycols listed below and the like may be used. Such materials may be employed at levels greater than 0.01, 0.05, 0.1, 0.2, 0.5, 0.9, 1.0, 1.1, 2.0, 3.0, 5, 9, 10, 11, 15 or 20% by wt.

| | |
|---|---|
| Polyox WSR-205 | PEG 14M, |
| Polyox WSR-N-60K | PEG 45M, or |
| Polyox WSR-N-750 | PEG 7M. |

Preferably hydrophobic emollients are used in excess of hydrophilic emollients in the inventive toilet skin care or cleansing composition. Hydrophobic emollients are preferably present in a concentration greater than about 0.01, 0.05, 0.1, 0.2, 0.5, 0.9, 1.0, 1.1, 2.0, 3.0, or up to about 5% by wt. The term “emollient” is defined as a substance which softens or improves the elasticity, appearance, and youthfulness of the skin (stratum corneum) by increasing its water content, and/or keeps it soft by retarding the decrease of its water content.

Useful emollients include the following:
(a) silicone oils and modifications thereof such as linear and cyclic polydimethylsiloxanes; amino, alkyl, alkylaryl, and aryl silicone oils;
(b) fats and oils including natural fats and oils such as jojoba, soybean, sunflower, rice bran, avocado, almond, olive, sesame, persic, castor, coconut, mink oils; cacao fat; beef tallow, lard; hardened oils obtained by hydrogenating the aforementioned oils; and synthetic mono, di and triglycerides such as myristic acid glyceride and 2-ethylhexanoic acid glyceride;
(c) waxes such as carnauba, spermaceti, beeswax, lanolin, and derivatives thereof;
(d) hydrophobic and hydrophilic plant extracts;
(e) hydrocarbons such as liquid paraffin, petrolatum, microcrystalline wax, ceresin, squalene, pristan and mineral oil;
(f) higher fatty acids such as lauric, myristic, palmitic, stearic, behenic, oleic, linoleic, linolenic, lanolic, isostearic, arachidonic and poly unsaturated fatty acids (PUFA);
(g) higher alcohols such as lauryl, cetyl, stearyl, oleyl, behenyl, cholesterol and 2-hexydecanol alcohol;
(h) esters such as cetyl octanoate, myristyl lactate, cetyl lactate, isopropyl myristate, myristyl myristate, isopropyl palmitate, isopropyl adipate, butyl stearate, decyl oleate, cholesterol isostearate, glycerol monostearate, glycerol distearate, glycerol tristearate, alkyl lactate, alkyl citrate and alkyl tartrate;
(i) essential oils and extracts thereof such as mentha, jasmine, camphor, white cedar, bitter orange peel, ryu, turpentine, cinnamon, bergamot, citrus unshiu, calamus, pine, lavender, bay, clove, hiba, eucalyptus, lemon, starflower, thyme, peppermint, rose, sage, sesame, ginger, basil, juniper, lemon grass, rosemary, rosewood, avocado, grape, grapeseed, myrrh, cucumber, watercress, calendula, elder flower, geranium, linden blossom, amaranth, seaweed, ginko, ginseng, carrot, guarana, tea tree, jojoba, comfrey, oatmeal, cocoa, neroli, vanilla, green tea, penny royal, aloe vera, menthol, cineole, eugenol, citral, citronelle, borneol, linalool, geraniol, evening primrose, camphor, thymol, spirantol, penene, limonene and terpenoid oils; and
(j) mixtures of any of the foregoing components, and the like.

Preferred emollients are selected from fatty acid(s), triglyceride oil(s), mineral oil(s), petrolatum, and mixtures thereof. Advantageously the emollient(s) is/are fatty acid(s).

Exfoliants

Exfoliants may be used. Such exfoliants used in the art include natural minerals such as silica, talc, calcite, pumice, tricalcium phosphate; seeds such as rice, apricot seeds, etc; crushed shells such as almond and walnut shells; oatmeal; polymers such as polyethylene and polypropylene beads, flower petals and leaves; microcrystalline wax beads; jojoba ester beads, and the like. These exfoliants come in a variety of particle sizes and morphology ranging from micron sized to a few mm. They also have a range of hardness. Some examples are given in table 1 below. Preferably such exfoliants are selected from softer varieties such as those with a Mohs hardness of less than about 4, 3, or 2. In a preferred embodiment, no exfoliants are used.

TABLE 1

| Material | Hardness (Mohs) |
|---|---|
| Talc | 1 |
| Calcite | 3 |
| Pumice | 4-6 |
| Walnut Shells | 3-4 |
| Dolomite | 4 |
| Polyethylene | ˜1 |

Optional Active Agents

Advantageously, active agents other than emollients defined above may be added to the toilet bar in a safe and effective amount. These active ingredients may be advantageously selected from antimicrobial and antifungal actives, vitamins, anti-acne actives; anti-wrinkle, anti-skin atrophy and skin repair actives; skin barrier repair actives; non-steroidal cosmetic soothing actives; artificial tanning agents and accelerators; skin lightening actives; sunscreen actives; sebum stimulators; sebum inhibitors; anti-oxidants; protease inhibitors; skin tightening agents; anti-itch ingredients; hair growth inhibitors; 5-alpha reductase inhibitors; desquamating enzyme enhancers; anti-glycation agents; topical anesthetics, or mixtures thereof; and the like.

Active agents may be selected from water soluble active agents, oil soluble active agents, pharmaceutically-acceptable salts and mixtures thereof. The term “active agent” as used herein, means personal care actives which can be used to deliver a benefit to the skin and/or hair and which generally are not used to confer a conditioning benefit, as is conferred by emollients previously described herein. The term “safe and effective amount” as used herein, means an amount of active agent high enough to modify the condition to be treated or to deliver the desired skin care benefit, but low enough to avoid serious side effects. The term “benefit,” as used herein, means the therapeutic, prophylactic, and/or chronic benefits associated with treating a particular condition with one or more of the active agents described herein. What is a safe and effective amount of the active agent ingredient will vary with the specific active agent, the ability of the active to penetrate through the skin, the age, health condition, and skin condition of the user, and other like factors. Preferably the toilet bars of the present invention comprise from about 0.01% to about 50%, more preferably from about 0.05% to about 25%, even more preferably 0.1% to about 10%, and most preferably 0.1% % to about 5%, by weight of the active agent component(s).

Anti-acne actives can be effective in treating acne vulgaris, a chronic disorder of the pilosebaceous follicles. Nonlimiting examples of useful anti-acne actives include the keratolytics such as salicylic acid (o-hydroxybenzoic acid), derivatives of salicylic acid such as 5-octanoyl salicylic acid and 4 methoxysalicylic acid, and resorcinol; retinoids such as retinoic acid and its derivatives (e.g., cis and trans); sulfur-containing D and L amino acids and their derivatives and salts, particularly their N-acetyl derivatives, mixtures thereof and the like.

Antimicrobial and antifungal actives can be effective to prevent the proliferation and growth of bacteria and fungi. Nonlimiting examples of antimicrobial and antifungal actives include b-lactam drugs, quinolone drugs, ciprofloxacin, norfloxacin, tetracycline, erythromycin, amikacin, 2,4,4′-trichloro-2′-hydroxy diphenyl ether, 3,4,4′-trichlorobanilide, phenoxyethanol, triclosan; triclocarban; and mixtures thereof and the like.

Anti-wrinkle, anti-skin atrophy and skin repair actives can be effective in replenishing or rejuvenating the epidermal layer. These actives generally provide these desirable skin care benefits by promoting or maintaining the natural process of desquamation. Nonlimiting examples of antiwrinkle and anti-skin atrophy actives include vitamins, minerals, and skin nutrients such as milk, vitamins A, E, and K; vitamin alkyl esters, including vitamin C alkyl esters; magnesium, calcium, copper, zinc and other metallic components; retinoic acid and its derivatives (e.g., cis and trans); retinal; retinol; retinyl esters such as retinyl acetate, retinyl palmitate, and retinyl propionate; vitamin B 3 compounds (such as niacinamide and nicotinic acid), alpha hydroxy acids, beta hydroxy acids, e.g. salicylic acid and derivatives thereof (such as 5-octanoyl salicylic acid, heptyloxy 4 salicylic acid, and 4-methoxy salicylic acid); mixtures thereof and the like.

Skin barrier repair actives are those skin care actives which can help repair and replenish the natural moisture barrier function of the epidermis. Nonlimiting examples of skin barrier repair actives include lipids such as cholesterol, ceramides, sucrose esters and pseudo-ceramides as described in European Patent Specification No. 556,957; ascorbic acid; biotin; biotin esters; phospholipids, mixtures thereof, and the like.

Non-steroidal cosmetic soothing actives can be effective in preventing or treating inflammation of the skin. The soothing active enhances the skin appearance benefits of the present invention, e.g., such agents contribute to a more uniform and acceptable skin tone or color. Nonlimiting examples of cosmetic soothing agents include the following categories: propionic acid derivatives; acetic acid derivatives; fenamic acid derivatives; mixtures thereof and the like. Many of these cosmetic soothing actives are described in U.S. Pat. No. 4,985,459 to Sunshine et al., issued Jan. 15, 1991, incorporated by reference herein in its entirety.

Artificial tanning actives can help in simulating a natural suntan by increasing melanin in the skin or by producing the appearance of increased melanin in the skin. Nonlimiting examples of artificial tanning agents and accelerators include dihydroxyacetaone; tyrosine; tyrosine esters such as ethyl tyrosinate and glucose tyrosinate; mixtures thereof, and the like.

Skin lightening actives can actually decrease the amount of melanin in the skin or provide such an effect by other mechanisms. Nonlimiting examples of skin lightening actives useful herein include aloe extract, alpha-glyceryl-L-ascorbic acid, aminotyroxine, ammonium lactate, glycolic acid, hydroquinone, 4 hydroxyanisole, mixtures thereof, and the like.

Also useful herein are sunscreen actives. A wide variety of sunscreen agents are described in U.S. Pat. No. 5,087,445, to Haffey et al., issued Feb. 11, 1992; U.S. Pat. No. 5,073,372, to Turner et al., issued Dec. 17, 1991; U.S. Pat. No. 5,073,371, to Turner et al. issued Dec. 17, 1991; and Segarin, et al., at Chapter VIII, pages 189 et seq., of Cosmetics Science and Technology, all of which are incorporated herein by reference in their entirety. Nonlimiting examples of sunscreens which are useful in the compositions of the present invention are those selected from the group consisting of octyl methoxyl cinnamate (Parsol MCX) and butyl methoxy benzoylmethane (Parsol 1789), 2-ethylhexyl p-methoxycinnamate, 2-ethylhexyl N,N-dimethyl-p-aminobenzoate, p-aminobenzoic acid, 2-phenylbenzimidazole-5-sulfonic acid, oxybenzone, mixtures thereof, and the like.

Sebum stimulators can increase the production of sebum by the sebaceous glands. Nonlimiting examples of sebum stimulating actives include bryonolic acid, dehydroetiandrosterone (DHEA), orizanol, mixtures thereof, and the like.

Sebum inhibitors can decrease the production of sebum by the sebaceous glands. Nonlimiting examples of useful sebum inhibiting actives include aluminum hydroxy chloride, corticosteroids, dehydroacetic acid and its salts, dichlorophenyl imidazoldioxolan (available from Elubiol), mixtures thereof, and the like.

Also useful as actives in the present invention are protease inhibitors. Protease inhibitors can be divided into two general classes: the proteinases and the peptidases. Proteinases act on specific interior peptide bonds of proteins and peptidases act on peptide bonds adjacent to a free amino or carboxyl group on the end of a protein and thus cleave the protein from the outside. The protease inhibitors suitable for use in the present invention include, but are not limited to, proteinases such as serine proteases, metalloproteases, cysteine proteases, and aspartyl protease, and peptidases, such as carboxypepidases, dipeptidases and aminopepidases, mixtures thereof and the like.

Other useful as active ingredients in the present invention are skin tightening agents. Nonlimiting examples of skin tightening agents which are useful in the compositions of the present invention include monomers which can bind a polymer to the skin such as terpolymers of vinylpyrrolidone, (meth)acrylic acid and a hydrophobic monomer comprised of long chain alkyl (meth)acrylates, mixtures thereof, and the like.

Active ingredients in the present invention may also include anti-itch ingredients. Suitable examples of anti-itch ingredients which are useful in the compositions of the present invention include hydrocortisone, methdilizine and trimeprazineare, mixtures thereof, and the like.

Nonlimiting examples of hair growth inhibitors which are useful in the compositions of the present invention include 17 beta estradiol, anti angiogenic steroids, curcuma extract, cycloxygenase inhibitors, evening primrose oil, linoleic acid and the like. Suitable 5-alpha reductase inhibitors such as ethynylestradiol and, genistine mixtures thereof, and the like.

Nonlimiting examples of desquamating enzyme enhancers which are useful in the compositions of the present invention include alanine, aspartic acid, N methyl serine, serine, trimethyl glycine, mixtures thereof, and the like.

A nonlimiting example of an anti-glycation agent which is useful in the compositions of the present invention would be Amadorine (available from Barnet Products Distributor), and the like.

Except in the operating and comparative examples, or where otherwise explicitly indicated, all numbers in this description indicating amounts of material ought to be understood as modified by the word “about”.

The following examples will more fully illustrate the embodiments of this invention. All parts, percentages and proportions referred to herein and in the appended claims are by weight unless otherwise illustrated. Physical test methods are described below:

The following inventive toilet bars may be formulated according to the manufacturing methods described below:

### EXAMPLE 1

### Mild Toilet Soaps

Mild toilet soaps A through G according to the invention may be prepared according to the formulations in Tables 1 through 7 respectively according to the method listed below.

TABLE 1
Toilet bar A.

| | Concentration |
|---|---|
| Ingredients | Range % by wt. |
| sodium cocoyl isethionate | 10-80% |
| coconut fatty acid | 1-15% |
| 50:50 blend of sulfomethyl esters and sulfonated fatty | 1-10% |
| acids with a carbon chain length range from C12-18 | |
| (1). | |
| 12-hydroxy stearic acid | 0.1-5% |
| sodium chloride | 0.5-5.0% |
| stearic acid | 2-25% |
| titanium dioxide | 0.001-1% |
| EHDP | 0.001-1% |
| EDTA | 0.001-1% |
| sodium isethionate | 1-10% |
| petrolatum | 0.1-5% |
| water | 0-10% |
| Total | 100% |

Note
(1); Alpha Step BSS 45 ® supplied by Stepan Corp. (Chicago, IL)

TABLE 2
Toilet bar B.

| | Concentration |
|---|---|
| Ingredients | Range % by wt. |
| sodium cocoyl isethionate | 60.50% |
| coconut fatty acid | 6.00% |
| 50:50 blend of sulfomethyl esters and sulfonated fatty | 3.00% |
| acids with a carbon chain length range from C12-18 | |
| 12-hydroxy stearic acid | 3.00% |
| sodium chloride | 0.75% |
| stearic acid | 15.00% |
| titanium dioxide | 0.15% |
| EHDP | 0.03% |
| EDTA | 0.03% |
| sodium isethionate | 5.00% |
| Petrolatum | 1.00% |
| Water | 5.50% |
| Total | 100% |

TABLE 3
Toilet bar C

| | Concentration |
|---|---|
| Ingredients | Range % by wt. |
| sodium cocoyl isethionate | 63.00% |
| coconut fatty acid | 6.00% |
| 50:50 blend of sulfomethyl esters and sulfonated fatty | 5.00% |
| acids with a carbon chain length range from C12-18. | |
| 12-hydroxy stearic acid | 2.50% |
| sodium chloride | 0.75% |
| stearic acid | 12.00% |
| titanium dioxide | 0.15% |
| EHDP | 0.03% |
| EDTA | 0.05% |
| sodium isethionate | 5.25% |
| Petrolatum | 0.27% |
| Water | 5.00% |
| Total | 100% |

TABLE 4
Toilet bar D

| | Concentration |
|---|---|
| Ingredients | Range % by wt. |
| sodium cocoyl isethionate | 60.00% |
| coconut fatty acid | 6.00% |
| Sodium laury ether sulfate (2 eo) Krafft point = 0 C. | 3.08% |
| Betaine | 5.00% |
| 12-hydroxy stearic acid | 2.50% |
| sodium chloride | 0.73% |
| stearic acid | 12.00% |
| titanium dioxide | 0.15% |
| EHDP | 0.03% |
| EDTA | 0.05% |
| sodium isethionate | 5.22% |
| Petrolatum | 0.25% |
| Water | 5.00% |
| Total | 100% |

TABLE 5
Toilet bar E

| | Concentration |
|---|---|
| Ingredients | Range % by wt. |
| sodium cocoyl isethionate | 62.00% |
| coconut fatty acid | 6.00% |
| Mono lauryl sulfosuccinate and mono cocoamido | 2.50% |
| MEA sulfosuccinate (1:1 blend) Krafft point <30 C. | |
| Betaine | 4.00% |
| 12-hydroxy stearic acid | 2.50% |
| sodium chloride | 0.73% |
| stearic acid | 11.63% |
| titanium dioxide | 0.15% |
| EHDP | 0.03% |
| EDTA | 0.05% |
| sodium isethionate | 5.20% |
| Petrolatum | 0.22% |
| Water | 5.00% |
| Total | 100% |

TABLE 6
Toilet bar F

| | Concentration |
|---|---|
| Ingredients | Range % by wt. |
| sodium cocoyl isethionate | 55.00% |
| coconut fatty acid | 6.00% |
| 50:50 blend of sulfomethyl esters and sulfonated fatty | 8.00% |
| acids with a carbon chain length range from C12-18. | |
| Krafft point <30 C. (1) | |
| 10-hydroxy palmitic acid | 2.50% |
| sodium chloride | 1.25% |
| stearic acid | 15.00% |
| titanium dioxide | 0.15% |
| EHDP | 0.03% |
| EDTA | 0.05% |
| sodium isethionate | 5.75% |
| Petrolatum | 1.27% |
| Water | 5.00% |
| Total | 100% |

Note
(1); Alpha Step BSS 45 ® supplied by Stepan Corp. (Chicago, IL)

TABLE 7
Toilet bar G

| | Concentration |
|---|---|
| Ingredients | Range % by wt. |
| sodium cocoyl isethionate | 60.00% |
| coconut fatty acid | 5.00% |
| Mono lauryl sulfosuccinate and mono cocoamido | 3.00% |
| sulfosuccinate (1:1 blend), Krafft point <30 C. | |
| C8-C18 olefin sulfonate (Krafft point <10 C.) | 4.00% |
| 12-hydroxy arachidic acid | 2.25% |
| sodium chloride | 1.00% |
| stearic acid | 11.50% |
| titanium dioxide | 0.15% |
| EHDP | 0.03% |
| EDTA | 0.05% |
| sodium isethionate | 8.00% |
| Water | 5.00% |
| Total | 100% |

Process for Making Bars A-G:

Stearic acid, monohydroxyl stearic/palmitic/arachadic acid and coco fatty acid are first melted in a z-blade mixer (at 80 to 90 C). Sodium cocoyl isethionate (SCI) is slowly added in the melt with continuous mixing at about 100-110 C. Once all the SCI is homogeneously dispersed, then other formulation ingredients are added one by one in the mixer and dispersed. After all the components are dissolved, the temperature is reduced to 95 C and water is adjusted to about 5-6%. The resulting mass is then chill roll milled (at 15 to 20 C). This milled material can be plodded directly or certain optional ingredients such fragrance, color, emotives (such as e.g. herbal extracts, vitamins, antibacterial agents, and the like) or other promotional ingredients can be added in the base, mixed in a chip mixer, milled and plodded.

Description of Test Methods

Methods of Testing

One or more of the following tests can be used to characterize the inventive toilet bars and compare it to comparative toilet bars.

a. Krafft Point Determination

Make up a 10% by wt. solution of surfactant in to be tested water. If needed, heat the system to dissolve the surfactant completely. Transfer the clear solution to a glass test tube. Place the test tube in a beaker equipped with a stirrer and filled with sufficient water to evenly cool the surfactant solution. The solution should be cooled with continuous stirring and the temperature should be continuously recorded. Note the temperature when the crystallization process begins such that the solution solution becomes turbid. This temperature is taken as the Krafft point. If the crystallization temperature is below room temperature, add ice to the beaker to gradually cool the test tube below room temperature to measure the subambient Krafft point. Measure the Krafft point as above.

b) Zein Test Method

The surfactant(s) or cleansing base of the inventive toilet bar preferably have zein solubilities of under about 50, 40, 30, and most preferably under about 25 using the zein solubility method set forth below. The lower the zein score, the milder the product is considered to be. This method involves measuring the solubility of zein (corn protein) in cleansing base solutions as follows:

0.3 g of cleansing base and 29.7 g of water are mixed thoroughly. To this is added 1.5 g of zein, and mixed for 1 hour. The mixture is then centrifuged for 30 minutes at 3000 rpm. After centrifugation, the pellet is extracted, washed with water, and dried in a vacuum oven for 24 hours until substantially all the water has evaporated. The weight of the dried pellet is measured and percent zein solubilized is calculated using the following equation:
% Zein solubilized=100 (1−weight of dried pellet/1.5).

The % Zein is further described in the following references: E. Gotte, Skin compatibility of tensides measured by their capacity for dissolving zein protein, Proc. IV International Congress of Surface Active Substances, Brussels, 1964, pp 83-90.

While this invention has been described with respect to particular embodiments thereof, it is apparent that numerous other forms and modifications of the invention will be obvious to those skilled in the art. The appended claims and this invention generally should be construed to cover all such obvious forms and modifications which are within the true spirit and scope of the present invention.

What is claimed is:

1. A mild toilet bar, comprising:
a. about 5 to 80% by wt. of total synthetic anionic surfactant(s);
b. about 1 to 20% by wt. of total surfactant(s) with a Krafft point of less than 30 C;
c. about 0.1 to 10% by wt. of total C16 to C20 mono hydroxy carboxylic acid(s);
d. about 3 to 15% by wt. of water;
e. less than about 10% by wt. of soap(s); and
f. less than about 5% by wt. of total hydrophobic and hydrophilic emollient(s) that are flowable liquids at 25 C; and
g. wherein the bar is formed via plodding or extrusion.

2. The bar of claim 1 wherein the surfactant(s) with a Krafft point of less than 30 C is (are) selected from anionic surfactants, nonionic surfactants, amphoteric surfactants, cationic surfactants and blends thereof.

3. The bar of claim 1 wherein at least 90% by wt. of the total C16 to C20 mono hydroxy carboxylic acid(s) is 12 hydroxy stearic acid.

4. The bar of claim 1 further comprising less than 1% by wt. of soap.

5. The bar of claim 1 further comprising a pH of in the range of about 5.0 to 7.5.

6. The bar of claim 1 wherein the low Krafft point surfactant is selected from C12-C18 sulfonated methyl esters, C12-C18 sulfonated fatty acids, sodium lauryl ether sulfate, betaine, mono lauryl sulfosuccinate, and mono cocoamido mea sulfosuccinate.

7. The bar of claim 1 wherein the total synthetic anionic surfactant to low Krafft point surfactant concentration is in the range of about 2 to 1 to about 100 to 1.

8. The bar of claim 3 wherein the ratio of C16 to C20 normal alkyl monohydroxyacids to flowable liquid emollient at 25 C is in the range of about 5 to 1 to about 1 to 5.

9. The bar of claim 1 wherein the bar contains less than about 6% by weight of water.

10. The bar of claim 1 further comprising hydrophilic emollient(s) at a concentration less than about 50% by wt of total emollient(s).

11. The bar of claim 1 further comprising hydrophobic emollient(s) at a concentration less than about 50% by wt of total emollient(s).

12. A toilet bar comprising:
a) less than about 5% by weight of total liquid emollient(s) with a melting point below 30 C.;
b) greater than 0.1% of total emollient(s) with a melting point above 30 C;
c) about 5% to 70% by weight of total surfactant(s);
d) more than about 5% by weight of 12-hydroxystearic acid; and
e) less than about 15% by wt. of water; and
f) wherein the bar is formed via plodding or extrusion.

13. The toilet bar of claim 12 where the emollient(s) with a melting point above 30 C is(are) hydrophilic emollients selected from polyhydric alcohols, polyols, saccharides, and mixtures thereof.

14. The toilet bar of claim 12 where the emollient(s) with a melting point above 30 C is(are) hydrophobic emollient(s) selected from triglyceride(s), hydrocarbon(s), silicone(s), fatty acid(s), fatty ester(s), fatty alcohol(s), and blends thereof.

15. The toilet bar of claim 12 wherein the total surfactant(s) includes at least one acyl isethionate.

16. The toilet bar of claim 15 wherein said acyl isethionate includes sodium cocoyl isethionate.
